(19) United States
(12) Patent Application Publication
(10) Pub. No.: US 2015/0254590 A1
(43) Pub. Date: Sep. 10, 2015

(54) PROCUREMENT PLAN CREATION DEVICE

(71) Applicant: HITACHI, LTD., Tokyo (JP)

(72) Inventors: Akihisa Tsujibe, Tokyo (JP); Kentaro Taguchi, Tokyo (JP); Takanari Inoue, Tokyo (JP)

(73) Assignee: HITACHI, LTD., Tokyo (JP)

(21) Appl. No.: 14/426,053

(22) PCT Filed: Nov. 9, 2012
(86) PCT No.: PCT/JP2012/079101

§ 371 Date: Mar. 4, 2015

(51) Int. Cl. G06Q 10/06

(52) U.S. Cl. CPC G06Q 10/06315

(57) ABSTRACT

The objective of the present invention is to provide, in the case of recreating a procurement plan, a technology which can create a procurement plan appropriate for the situation even without a skilled operator. A procurement plan creation device according to the present invention has predefined definitions for second constraint conditions in which constraint conditions related to a procurement plan have been relaxed, and creates a plurality of second procurement plans according to combinations of the second constraint conditions and presents the plurality of second procurement plans to an operator (see FIG. 15).

### TECHNICAL FIELD

The present invention relates to a technique for preparing procurement plans.

### BACKGROUND ART

It is necessary to prepare a procurement plan of products considering such as the number of required products, supply capacity of manufacturer, or product transportation. Thus a procurement plan has an aspect as an optimization problem where complicated constraints exist. Patent Literatures 1-2 listed below describe techniques for acquiring optimized solutions under given constraints.

Patent Literature 1 listed below describes a technique as “ . . . configures multiple constraints as necessary constraints and as alleviated constraints, simulates a case using the configured constraints, and displays a simulation result. At this time, a correction for the simulation result is received from a skilled person, the configuration of the necessary constraints and of the alleviated constraints is reconfigured according to the corrected portion and to the correction process, and the case is re-simulated.” (refer to Abstract).

Patent Literature 2 listed below describes a technique as “ . . . when assuming that either the secured order is removed from the manufacturing plan or the supply capacity is increased, if the desired delivery date of the unsecured order and the desired amount of the unsecured order are satisfied, the manufacturing plan is re-prepared by at least any one of removing the selected secured order and increasing the supply capacity.” (refer to Abstract)

### CITATION LIST

### Patent Literature

Patent Literature 1: JP Patent Publication (Kokai) 2006-323784 A

Patent Literature 2: JP Patent Publication (Kokai) 2006-155366 A

### SUMMARY OF INVENTION

### Technical Problem

In the technique described in Patent Literature 1, it is necessary for an operator to categorize multiple constraints into necessary constraints and into alleviated constraints according to the simulation result. It is also necessary to correct the acceptable value of the alleviated constraints. Therefore, technical capability and know-how of the operator significantly affect the calculated simulation result.

In the technique described in Patent Literature 2, a new manufacturing plan in which prioritized unsecured orders are assigned is re-prepared by removing secured orders and by increasing supply capacity. However, it may be difficult to appropriately re-prepare the manufacturing plan without considering means other than removing secured orders or increasing supply capacity. For example, the manufacturing plan can also be re-prepared by means such as forwarding manufacturing periods, adjusting supply requests, reducing transportation periods, or reconfiguring transportation costs. In other words, it may be necessary to consider means other than merely increasing or decreasing requested amounts or supplied amounts.

The present invention is made in the light of the above-described technical problems. It is an objective of the present invention to provide a technique being capable of preparing, when re-preparing a procurement plan, an appropriate procurement plan according to situations even without skilled operators.

### Solution to Problem

A procurement plan preparation device according to the present invention: previously defines a second constraint in which a constraint for a procurement plan is alleviated; prepares a plurality of second procurement plans by combining the second constraints; and presents the second procurement plan to an operator.

### Advantageous Effects of Invention

Since the procurement plan preparation device according to the present invention prepares the second procurement plan by combining the second constraints in which the constraint is alleviated, the number of combinations is lower than that of the all combinations. Thus the processing load may be suppressed. In addition, it is possible not only to increase or decrease supplied amounts or requested amounts but also to consider various constraints. Thus it is possible to prepare more appropriate procurement plans.

Technical problems, configurations, and effects other than mentioned above will be understood with reference to the following embodiments.

### BRIEF DESCRIPTION OF DRAWINGS

FIG. 1 is a functional block diagram of a procurement plan preparation device 10 according to an embodiment 1.

FIG. 2 is a diagram showing a configuration example of base information 1311 stored in a master information storage 131.

FIG. 3 is a diagram showing a configuration example of supplier production plan information 1312 stored in the master information storage 131.

FIG. 4 is a diagram showing a configuration example of stock information 1313 stored in the master information storage 131.

FIG. 5 is a diagram showing a configuration example of consumption plan information 1314 stored in the master information storage 131.

FIG. 6 is a diagram showing a configuration example of transportation information 1315 stored in the master information storage 131.

FIG. 7 is a diagram showing a configuration example of supply request information 1316 stored in the master information storage 131.

FIG. 8 is a diagram showing a configuration example of target alleviation information 1321 stored in an alleviated constraint storage 132.

FIG. 9 is a diagram showing a configuration example of additional transportation cost alleviation information 1322 stored in the alleviated constraint storage 132.

FIG. 10 is a diagram showing a configuration example of transportation days alleviation information 1323 stored in the alleviated constraint storage 132.

FIG. 11 is a diagram showing a configuration example of production increase alleviation information 1324 stored in the alleviated constraint storage 132.

FIG. 12 is a diagram showing a configuration example of supply forward alleviation information 1325 stored in the alleviated constraint storage 132.

FIG. 13 is a flowchart showing an operation of the procurement plan preparation device 10.

FIG. 14 is a diagram exemplifying an alleviated constraint combination list 1231 created by a combination creator 123 in step S3.

FIG. 15 is a diagram showing a configuration example of a procurement plan list screen 1411 displayed by a procurement plan list displayer 141 in step S6.

FIG. 16 is a diagram showing a configuration example of procurement plan information 1281 outputted by an output controller 128.

FIG. 17 is a functional block diagram of the procurement plan preparation device 10 according to an embodiment 2.

FIG. 18 is a flowchart showing an operation of the procurement plan preparation device 10 according to the embodiment 2.

### DESCRIPTION OF EMBODIMENTS

A procurement plan preparation device according to the present invention is used for correcting a procurement plan to prepare a new procurement plan if a procurement request issued from a buyer of a product toward a supplier cannot be satisfied.

In the present invention, when transporting a procured product, it is assumed that multiple of transportation means is used. For example, there is a transportation means with long transportation time and with low transportation cost such as ship transportation, and there also is a transportation means with short transportation time and with high transportation cost such as air transportation. Hereinafter, for the sake of simplicity of description, ship transportation and air transportation are assumed as transportation means. However, the transportation means may be train transportation or track transportation, or combination thereof. Further, there may be more than two transportation means.

### Embodiment 1

### Device Configuration

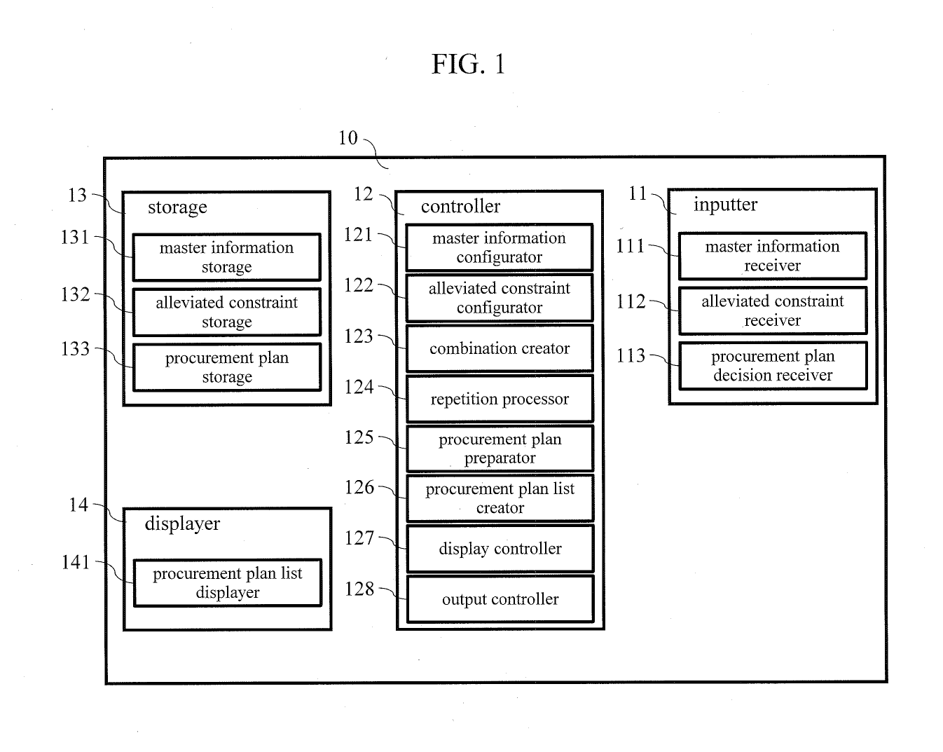

FIG. 1 is a functional block diagram of a procurement plan preparation device 10 according to an embodiment 1 of the present invention. The procurement plan preparation device 10 includes an inputter 11, a controller 12, a storage 13, and a displayer 14. The inputter 11 includes a master information receiver 111, an alleviated constraint receiver 112, and a procurement plan decision receiver 113. The controller 12 includes a master information configurator 121, an alleviated constraint configurator 122, a combination creator 123, a repetition processor 124, a procurement plan preparator 125, a procurement plan list creator 126, a display controller 127, and an output controller 128. The storage 13 includes a master information storage 131, an alleviated constraint storage 132, and a procurement plan storage 133. The displayer 14 includes a procurement plan list displayer 141. Operations of each functional unit will be described later.

The inputter 11, the controller 12, and each functional unit included therein may be configured using hardware such as circuit devices implementing these functions, or may be configured by a processor executing software implementing these functions. The storage 13 may be configured by storage devices such as hard disk drives. The displayer 14 may be configured by display devices and control functions thereof.

### Embodiment 1

### Master Information

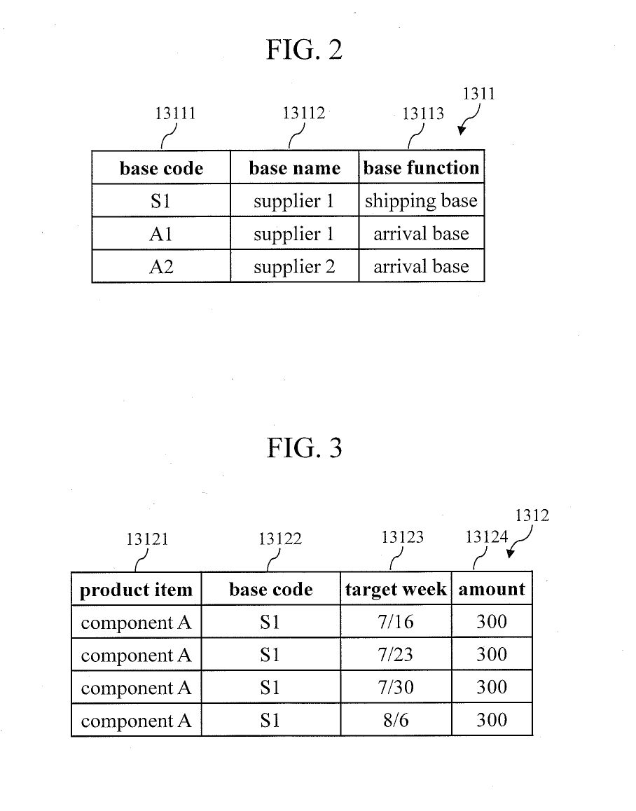

The master information storage 131 stores fundamental information regarding the procurement plan. Each information stored in the master information storage 131 will be described using FIGS. 2-7.

FIG. 2 is a diagram showing a configuration example of base information 1311 stored in the master information storage 131. The base information 1311 is a data table storing information regarding destinations and senders of products such as manufacturing bases or consumption bases. The base information 1311 stores a base code 13111, a base name 13112, and a base functionality 13113.

The base code 13111 stores IDs that identify suppliers and destinations (hereinafter, referred to as bases) of products regarding the procurement plan. The base name 13112 stores names of the bases. The base functionality 13113 stores types of the bases (shipping base (=supplying base)/arrival base (=destination base)). According to the first record, it is understood that the base with the base code “S1” has a base name of “supplier 1” and its base type is “shipping base”.

FIG. 3 is a diagram showing a configuration example of supplier production plan information 1312 stored in the master information storage 131. The supplier production plan information 1312 stores a product item 13121, a base code 13122, a target week 13123, and an amount 13124.

The product item 13121 stores names of product items. The base code 13122 stores base codes of bases where the product item is produced. The target week 13123 stores weeks when the product item is produced at the base. The amount 13124 stores amounts of the product item produced at the base within the target week. According to the first record, it is understood that the product item “component A” is produced by amount of “300” at the base code “S1” in the target week “7/16”.

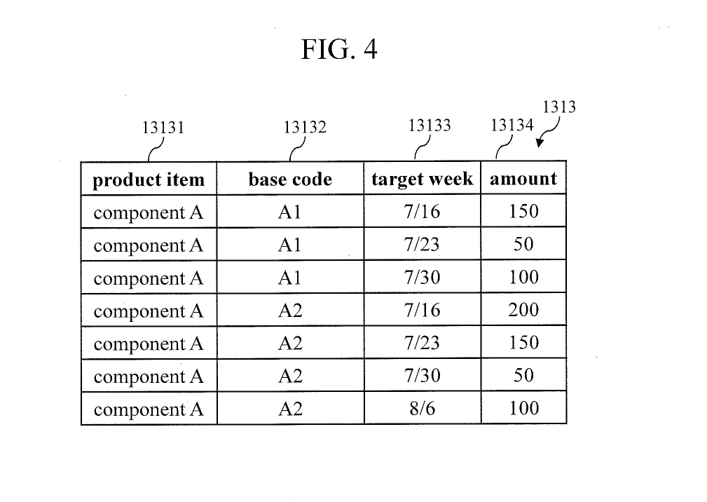

FIG. 4 is a diagram showing a configuration example of stock information 1313 stored in the master information storage 131. The stock information 1313 is a data table that stores information regarding stocks of products. The stock information 1313 includes a product type 13131, a base code 13132, a target week 13133, and an amount 13134.

The product item 13131 stores names of product items. The base code 13132 stores base codes of bases where the product item is stored as stocks. The target week 13133 stores weeks when the product item changes from a transferred state into a stocked state at the base. The amount 13134 stores amounts by which the product item newly becomes stocks at the base in the target week. According to the first record, “150” stocks of the product item “component A” are generated at the base code “A1” in the target week “7/16”.

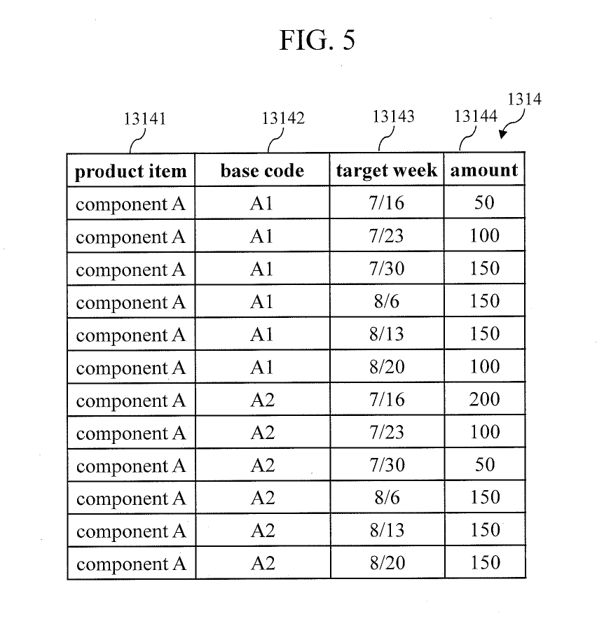

FIG. 5 is a diagram showing a configuration example of consumption plan information 1314 stored in the master information storage 131. The consumption plan information 1314 is a data table that describes schedules for the products to be consumed by being put into production lines or the like. The consumption plan information 1314 stores a product item 13141, a base code 13142, a target week 13143, and an amount 13144.

The product item 13141 stores names of product items. The base code 13142 stores base codes of bases where the product item is consumed by such as production processes. The target week 13143 stores weeks when the product item is consumed at the base. The amount 13144 stores amounts by which the product item is consumed at the base in the target week. According to the first record, it is understood that the product item “component A” is consumed by amount of “50” at the base code “A1” in the target week “7/16”.

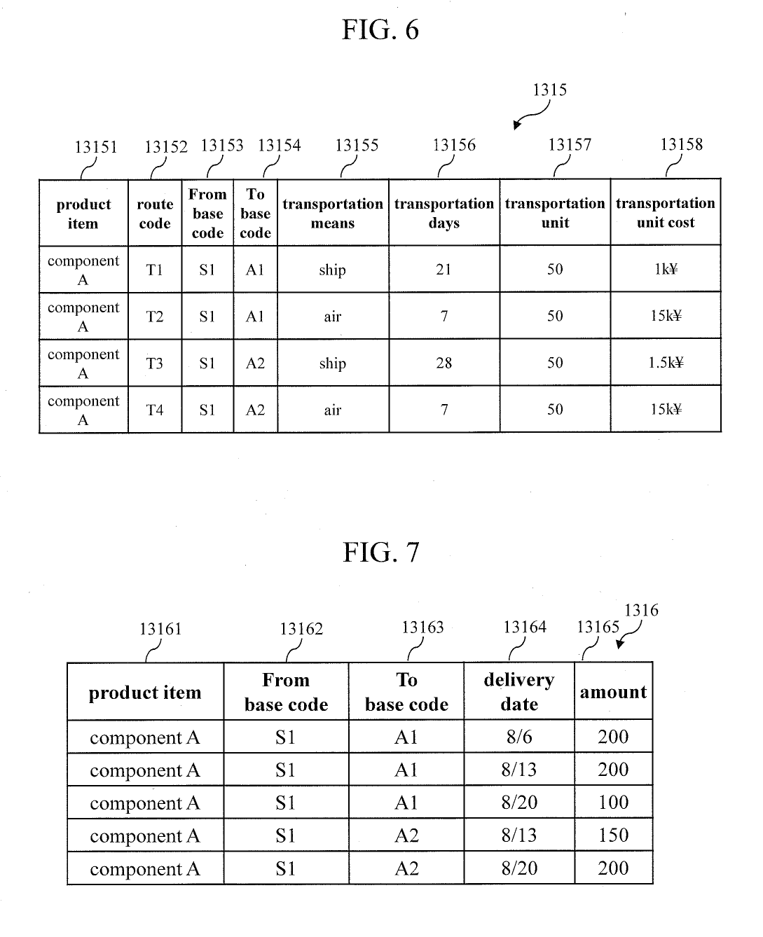

FIG. 6 is a diagram showing a configuration example of transportation information 1315 stored in the master information storage 131. The transportation information 1315 is a data table that describes resources required for transporting products. The transportation information 1315 stores a product item 13151, a route code 13152, a From base code 13153, a To base code 13154, a transportation means 13155, a transportation days 13156, a transportation unit 13157, and a transportation unit cost 13158.

The product item 13151 stores names of product items. The route code 13152 stores IDs for identifying transportation routes. The From base code 13153 stores base codes indicating shipping bases (=supplier). The To base code 13154 stores base codes indicating arrival bases (=destination). The transportation means 13155 stores transportation means for the product item routed through the route code. The transportation days 13156 stores days to transport the product item routed through the route code. The transportation unit 13157 is a unit amount by which the product item is transported through the route code. The transportation unit cost 13158 stores transportation costs for transporting one of the product through the route code. According to the first record, when transporting the product item “component A” by transportation means “ship” from the base “S1” to the base “A1” through the route code “T1”, the transportation takes “21” days, the product item is transported by unit amount of “50”, and it incurs transportation cost of “1000 JPY” for each of products.

FIG. 7 is a diagram showing a configuration example of supply request information 1316 stored in the master information storage 131. The supply request information 1316 is a data table that enumerates requests to ship products from suppliers to destinations. The supply request information 1316 stores a product item 13161, a From base code 13162, a To base code 13163, a delivery date 13164, and an amount 13165.

The product item 13161 stores names of product items. The From base code 13162 stores base codes indicating shipping bases (=supplier). The To base code 13163 stores base codes indicating arrival bases (=destinations). The delivery date 13164 stores arrival deadline dates when the product item is transported from the From base code toward the To base code. The amount 13165 stores amounts of request to transport the product item by the delivery date from the From base code toward the To base code. According to the first record, the product item “component A” is requested to be transported by amount of “200” from “S1” toward “A1” by “8/6”.

### Embodiment 1

### Alleviated Constraint

The alleviated constraint storage 132 stores data that describes alleviated constraints in which constraints for the procurement plan are alleviated. The alleviated constraint mentioned here is a new constraint that is configured so that the ratio of satisfied procurement requests will be increased.

For example, when it becomes hardly likely to satisfy a procurement plan due to such as disasters, it is necessary to re-prepare the procurement plan so that as many as procurement requests will be satisfied. The alleviated constraint defines in advance constraints that can be alleviated at such time. The constraints that can be alleviated depend on environments. Thus the alleviated constraint is previously defined and is stored in the alleviated constraint storage 132.

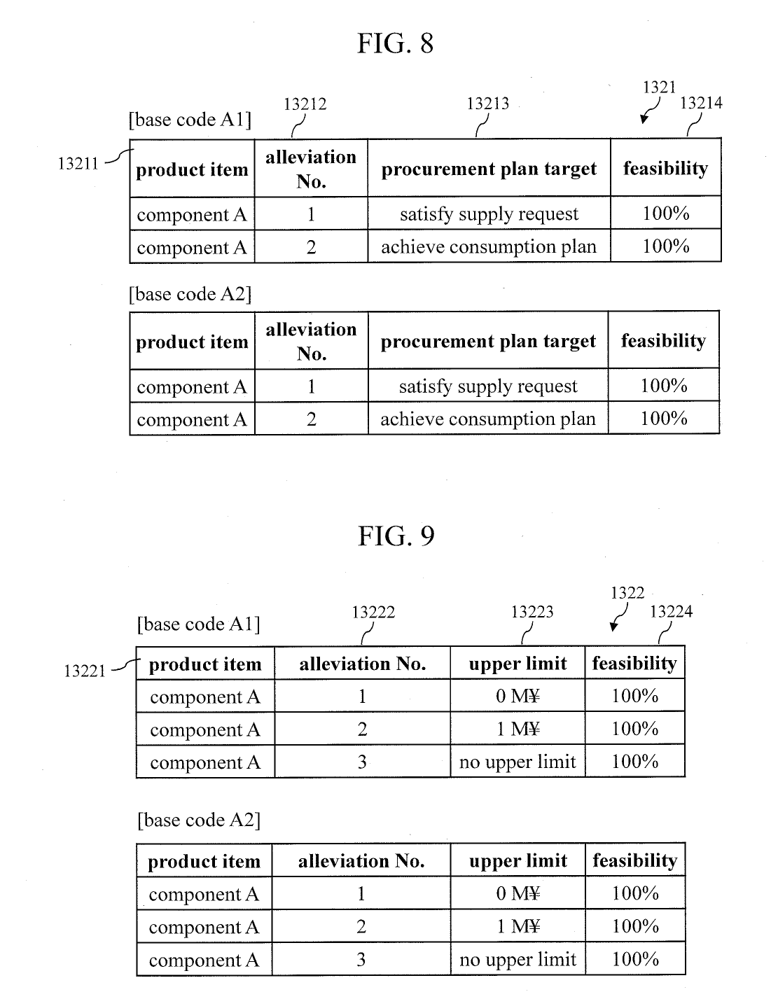

FIG. 8 is a diagram showing a configuration example of target alleviation information 1321 stored in the alleviated constraint storage 132. The target alleviation information 1321 is data that defines alleviated constraints regarding procurement target. The target alleviation information 1321 stores a product item 1321, an alleviation No. 13212, a procurement plan target 13213, and a feasibility 13214.

The product item 13211 stores names of product items. The alleviation No. 13212 stores IDs for identifying alleviated constraints. The procurement plan target 13213 stores contents of alleviated constraints of the alleviation No. 13212. The feasibility 13214 stores quantified probabilities with which the alleviated constraints of the alleviation No. is achieved.

The alleviation No. “1” is a constraint that secures fully satisfying the procurement request, which is the most strict constraint. The alleviation No. “2” is a constraint that secures satisfying the minimum amount of objects put into the production lines or the like, which is an alleviated constraint compared to the alleviation No. “1”. The constraints described in this table are manually configured by such as administrators as procurement targets (alleviated constraints) in which the original targets are alleviated. The procurement target can be described as one of constraints, thus it is described in the same format as that of other constraints described below.

In the example shown in FIG. 8, two types of targets are exemplified as a target to fully satisfy supply requests and as a target to fully satisfy consumption plans. However, other alternative targets may be configured. For example, the targets may be such as achieving safe stocks or achieving 90% of consumption plan. The alleviated constraints described in this table are all configured by human decisions. Thus the feasibility 13214 is 100%. Since the achievement targets are different for each of suppliers, it is necessary to provide this table for each of suppliers. If a same supplier has different achievement targets for each of destinations, this table may be further separated for each of destinations.

FIG. 9 is a diagram showing a configuration example of additional transportation cost alleviation information 1322 stored in the alleviated constraint storage 132. The additional transportation cost alleviation information 1322 is a data table that describes acceptable transportation costs as additional costs when using emergency transportation means to achieve the procurement plan. The additional transportation cost alleviation information 1322 stores a product item 13221, an alleviation No. 13222, an upper limit 13223, and a feasibility 13224.

The product item 13221 stores names of product items. The alleviation No. 13222 stores IDs for identifying alleviated constraints. The upper limit 13223 stores acceptable upper limits of additional transportation costs that are incurred when using emergency transportation means. The feasibility 13224 stores quantified probabilities with which the alleviated constraints of the alleviation No. is achieved.

If the upper limit 13223 is 0M JPY, it means that no emergency transportation is allowed. If the upper limit 13223 is “no upper limit”, it means that no upper limit of cost is provided for emergency transportation means. The alleviated constraints described in this table are all configured by human decisions. Thus the feasibility 13224 is 100%. Since the upper limits of additional transportation cost are different for each of suppliers, it is necessary to provide this table for each of suppliers. If a same supplier has different upper limits of cost for each of destinations, this table may be further separated for each of destinations.

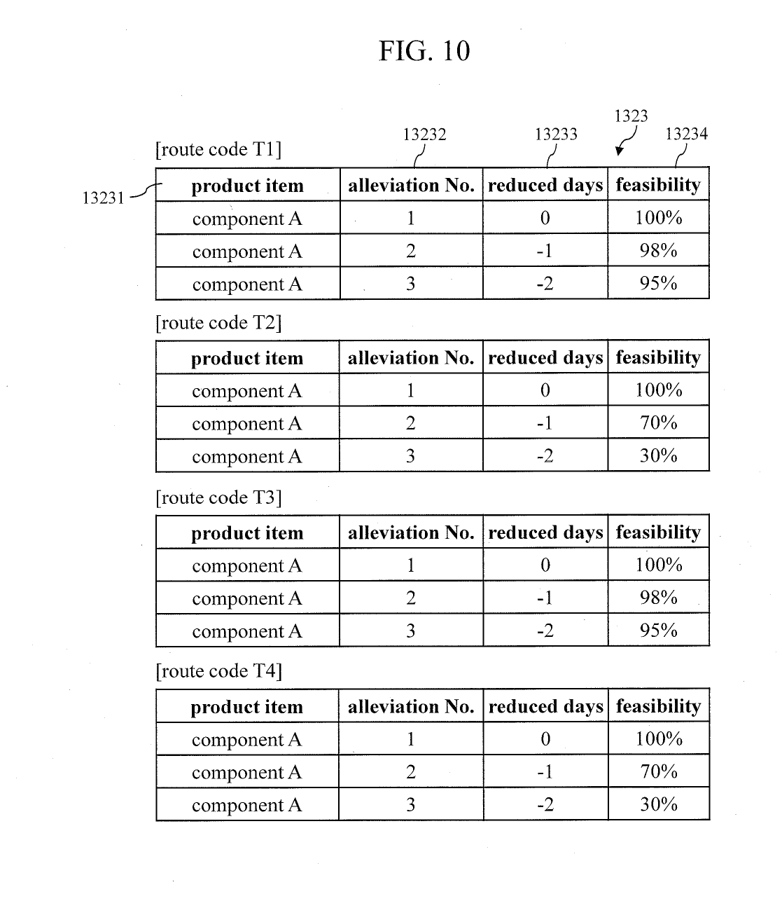

FIG. 10 is a diagram showing a configuration example of transportation days alleviation information 1323 stored in the alleviated constraint storage 132. The transportation days alleviation information 1323 is a data table describing transportation days that can be reduced to achieve the procurement plan. The transportation days alleviation information stores a product item 13231, an alleviation No. 13232, a reduced days 13233, and a feasibility 13234.

The product item 13231 stores names of product items. The alleviation No. 13232 stores IDs for identifying alleviated constraints. The reduced days 13233 stores transportation days that can be reduced. The feasibility 13234 stores quantified probabilities with which the alleviated constraints of the alleviation No. is achieved.

The feasibility 13234 is configured according to such as statistically processed results based on past records, to hearing information from interested parties, or to know-how of skilled persons. Since the days that can be reduced and the feasibility are different for each of transportation routes, it is necessary to provide this table for each of transportation routes.

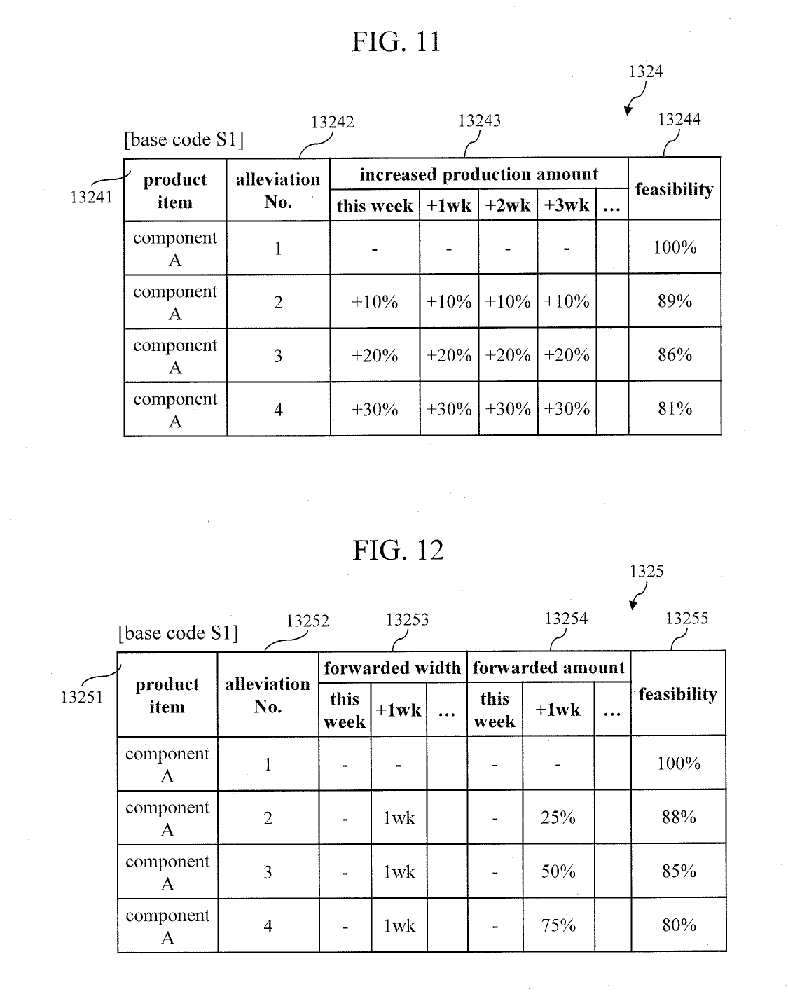

FIG. 11 is a diagram showing a configuration example of production increase alleviation information 1324 stored in the alleviated constraint storage 132. The production increase alleviation information 1324 is a data table describing product items which production amount that can be increased to achieve the procurement plan and describing the increased production amount. The production increase alleviation information 1324 stores a product item 13241, an alleviation No. 13242, an increased production amount 13243, and a feasibility 13244.

The product item 13241 stores names of product items. The alleviation No. 13242 stores IDs for identifying alleviated constraints. The increased production amount 13243 stores increased ratio of supplied products for each of weeks counting from the current week, for example. The feasibility 13244 stores quantified probabilities with which the alleviated constraints of the alleviation No. is achieved.

The alleviation No. “1” is a record that describes the production plan itself provided from the supplier. The increased production amount 13243 thereof is “-” indicating no change and the feasibility 13244 thereof is 100%. The alleviation No. “2” indicates that the production plan provided from the supplier is increased by +10% every week. As the increased production amount 13243 increases, the production capacity is strained. Thus the feasibility 13244 becomes smaller. The feasibility 13244 is configured according to such as statistically processed results based on past records, to hearing information from interested parties, or to know-how of skilled persons. The increased production amount 13243 may be described, other than for each of weeks, for each of days or months. This table may be provided for each of supplying bases.

FIG. 12 is a diagram showing a configuration example of supply forward alleviation information 1325 stored in the alleviated constraint storage 132. The supply forward alleviation information 1325 is a data table describing product items which production amounts can be forwarded to achieve the procurement plan and describing the forwarded production amounts. The supply forward alleviation information 1325 stores a product item 13251, an alleviation No. 13252, a forwarded width 13253, a forwarded amount 13254, and a feasibility 13255.

The product item 13251 stores names of product items. The alleviation No. 13252 stores IDs for identifying alleviated constraints. The forwarded width 13253 describes days by which the production is forwarded, for example using number of forwarded weeks. The forwarded amount 13254 describes amounts of forwarded productions, for example using increased ratios with respect to the production amounts before increased. The feasibility 13255 stores quantified probabilities with which the alleviated constraints of the alleviation No. is achieved.

The alleviation No. “1” is a record that describes the production plan itself provided from the supplier. The forwarded width 13253 and the forwarded amount 13254 are “-” indicating no change and the feasibility 13255 thereof is 100%. The alleviation No. “2” indicates that the production plan of the next week (+1 wk) provided from the supplier is increased by 25% in this week. The feasibility 13255 is configured according to such as statistically processed results based on past records, to hearing information from interested parties, or to know-how of skilled persons. The forwarded width 13253 and the forwarded amount 13254 may be described, other than for each of weeks, for each of days or months. This table may be provided for each of supplying bases.

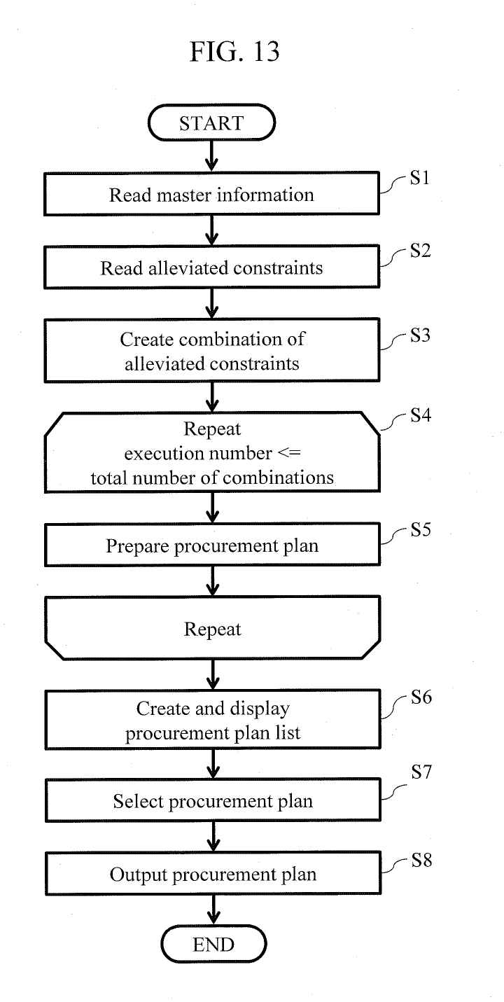

FIG. 13 is a flowchart showing an operation of the procurement plan preparation device 10. Hereinafter, each step in FIG. 13 will be described in details.

### (FIG. 13: Step S1: Read Master Information)

The master information receiver 111 receives inputs of each master information described in FIGS. 2-7. The master information configurator 121 stores each of the received master information into the master information storage 131.

### (FIG. 13: Step S2: Read Alleviated Constraints)

The alleviated constraint receiver 112 receives inputs of each alleviated constraint information described in FIGS. 8-12. The alleviated constraint configurator 122 stores each of alleviated constraint information into the alleviated constraint storage 132. As shown in FIGS. 8-12, the embodiment 1 uses five alleviation axes. Each alleviation axis is classified for each of bases or transportation routes. Alleviation amounts or feasibilities are different for each of components/product items in all alleviation axes. Thus the alleviation amounts and the feasibilities are uniquely defined by “product item”, “base/route code”, and “alleviation No.”.

### (FIG. 13: Step S3: Create Combination of Alleviated Constraints)

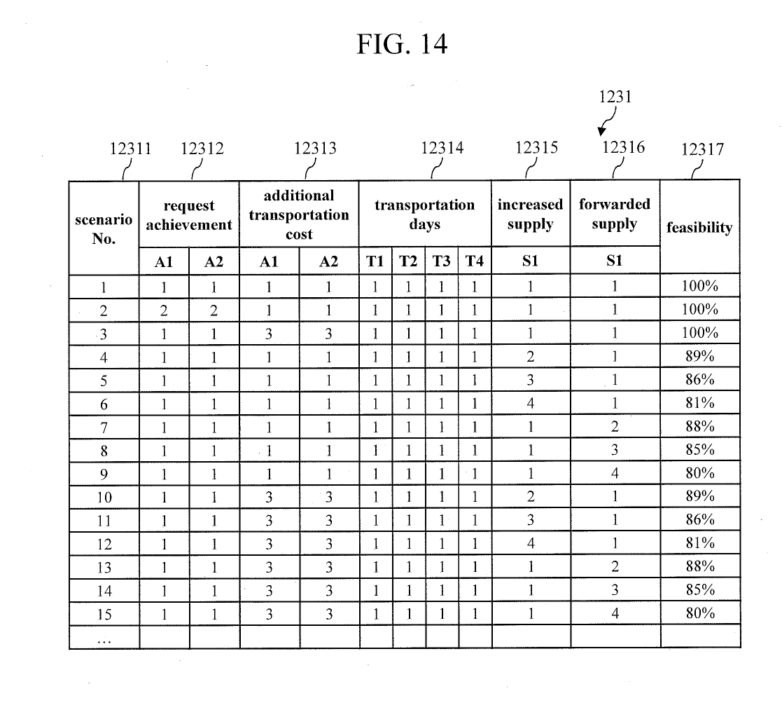

The combination creator 123 creates combinations of alleviated constraints for each of product items using round-robin of the alleviation No. of each alleviation axis. The alleviation No. is selected for each of the bases. Thus the number of combinations of alleviated constraints in one alleviation axis is the number of alleviation No. to the number of bases-th power. The total number of combinations in the embodiment 1 is 2²×3²×3¹×4¹×4¹=46656. The combination list of alleviated constraints created in this step will be exemplified in FIG. 14 later.

### (FIG. 13: Step S4: Repeat)

The repetition processor 124 performs step S5 for each of alleviated scenarios (temporal procurement plan to which the alleviated constraints are applied instead of the original constraints) that are enumerated in the combination list of alleviated constraints created by the combination creator 123.

### (FIG. 13: Step S5: Prepare Procurement Plan)

The procurement plan preparator 125: reads out information stored in the master information storage 131 and in the alleviated constraint storage 132; performs optimization simulation for each of alleviated scenarios enumerated in the combination list of alleviated constraints; and stores the simulation result into the procurement plan storage 133. The optimization method used by the procurement plan preparator 125 to perform the simulation may be optimization algorithms such as branch and bound method, dynamic programming, linear programming, heuristics, greedy method, local search, genetic algorithm, simulated annealing, or taboo search, or combinations thereof.

### (FIG. 13: Step S6: Create and Display Procurement Plan List)

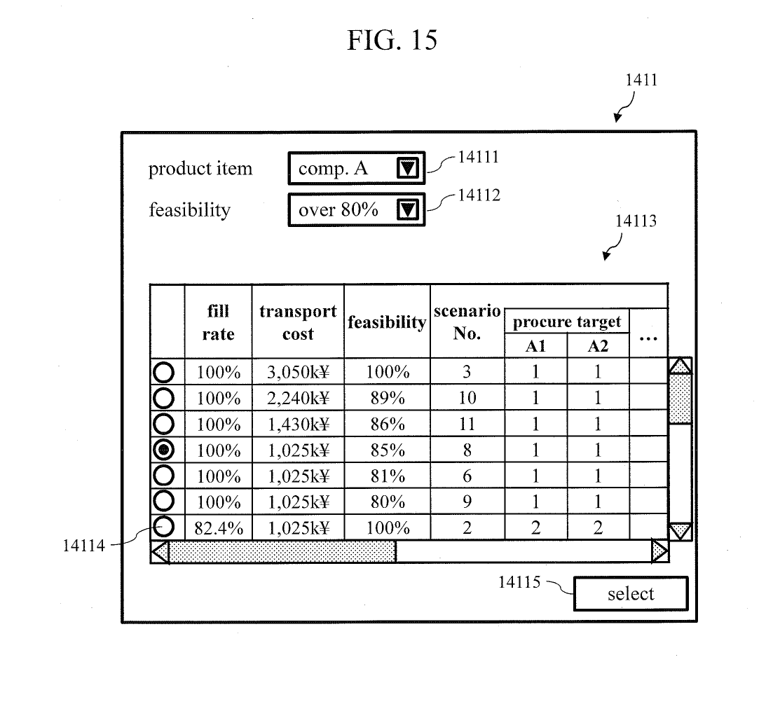

The procurement plan list creator 126 outputs, in a format of list, the simulation results of all alleviated scenarios enumerated in the alleviated constraints combination list. The display controller 127 filters, according to item names and to KPI values, the procurement plan list created by the procurement plan list creator 126. The display controller 127 further sorts the simulation results in descending order of KPI value. The procurement plan list displayer 141 displays the procurement plan list. An example of the display in this step will be described in FIG. 15 later.

### (FIG. 13: Step S7: Select Procurement Plan)

The operator selects any one of procurement plans on the screen displayed by the procurement plan list displayer 141. The procurement plan decision receiver 113 receives the selection input and notifies it to the output controller 128.

### (FIG. 13: Step S8: Output Procurement Plan)

The output controller 128 outputs output data that describes the procurement plan selected in step S7 and that describes the alleviated constraints. The output data may be outputted, for example, to networks or storage devices in any data format or other output formats may be employed.

### Embodiment 1

### Display Example

FIG. 14 is a diagram exemplifying the alleviated constraint combination list 1231 created by a combination creator 123 in step S3. The alleviated constraint combination list 1231 stores a scenario No. 12311, a request achievement 12312, an additional transportation cost 12313, a transportation days 12314, an increased supply 12315, a forwarded supply 12316, and a feasibility 12317.

The scenario No. 12311 stores IDs for identifying combinations of alleviated constraints. The request achievement 12312—the feasibility 12317 store values of the alleviation No. in each table of FIGS. 8-12 that are used in the alleviation scenario. In other words, each of the alleviated scenario is created using combinations of the alleviation No. in each table of FIGS. 8-12. The feasibility 12317 is a quantified probability with which the alleviated scenario is actually achieved. The feasibility 12317 is calculated by multiplying the feasibilities in all alleviated scenarios.

The first record is an example in which an alleviated scenario is created using the alleviation No. “1” in each table of FIGS. 8-12. Since the feasibilities of these alleviated constraints are all “100%”, the feasibility 12317 of this alleviated scenario is 100%.

FIG. 15 is a diagram showing a configuration example of a procurement plan list screen 1411 displayed by the procurement plan list displayer 141 in step S6. The procurement plan list screen 1411 includes a product item selection area 14111, a feasibility selection area 14112, a procurement plan summary 14113, a scenario selection area 14114, and a selection button 14115.

The product item selection area 14111 is an area to select alleviated scenarios that are to be displayed on the procurement plan list screen 1411. This selection area is provided because multiple of alleviated scenarios may be created for each of product items. Multiple of product items may be selected or a product item may be selected according to some conditions. The procurement plan list displayer 141 only displays alleviated scenarios, among the alleviated constraint combination list 1231, corresponding to product items selected in this selection area.

The feasibility selection area 14112 is an area to select alleviated scenarios that are to be displayed on the procurement plan list screen 1411, as for the product item selection area 14111. The procurement plan list displayer 141 only displays alleviated scenarios, among the alleviated constraint combination list 1231, that have the feasibility 12317 above values selected in this selection area. This selection area may be configured so that a range of values is selected.

The procurement plan summary 14113 is an area that enumerates alleviated scenarios filtered by the product item selection area 14111 and by the feasibility selection area 14112. The procurement plan list displayer 141 sorts each alleviated scenario according to sort conditions of at least any one of descending order of procurement plan fill rate, descending order of the feasibility 12317, and ascending order of transportation cost. The procurement plan list displayer 141 displays the sorted result.

The procurement plan fill rate is a ratio of procurement requests, among all procurement requests, which request is satisfied (the product arrived at or before the specified delivery date). If all procurement requests are satisfied, the fill rate of the alleviated scenario is 100%. The transportation cost is a sum of normal transportation cost and additional transportation cost.

Details of each alleviated scenario may be displayed in the same form of the alleviated constraint combination list 1231, or may be additionally complemented using texts or images of each alleviated scenario contents so that the operator easily understands the scenario. Contents of each alleviated scenario may be displayed in this screen or may be displayed in sub windows. FIG. 15 shows an example where this screen displays the scenario.

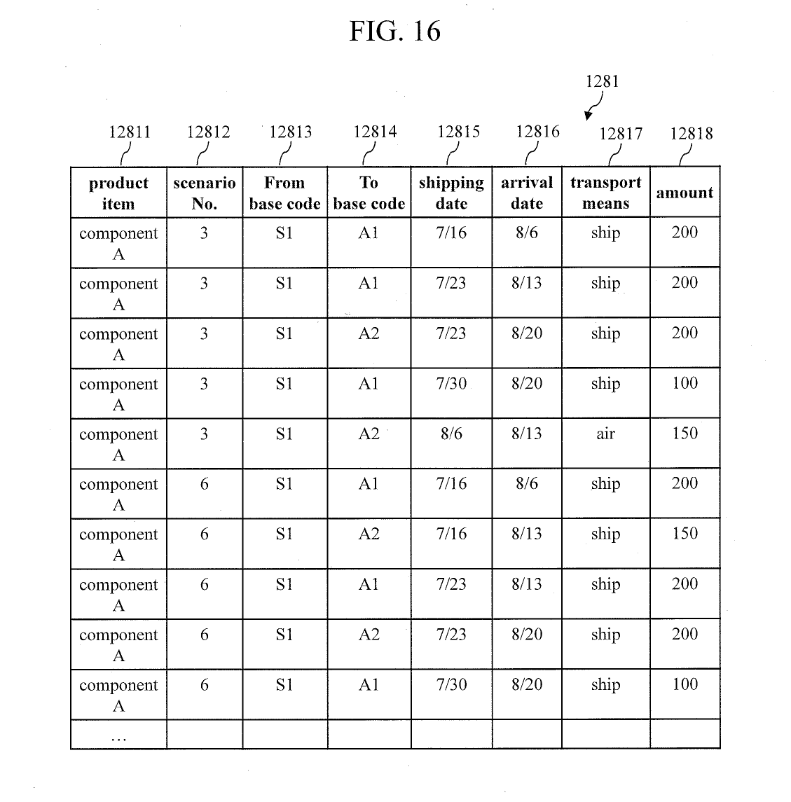

FIG. 16 is a diagram showing a configuration example of procurement plan information 1281 outputted by the output controller 128. The procurement plan information 1281 stores a product item 12811, a scenario No. 12812, a From base code 12813, a To base code 12814, a shipping date 12815, an arrival date 12816, a transportation means 12817, and an amount 12818.

The product item 12811 stores names of product items. The scenario No. 12812 stores IDs for identifying combinations of alleviated constraints. The From base code 12813 stores base codes of shipping bases. The To base code 12814 stores base codes of arrival bases. The shipping date 12815 and the arrival date 12816 store shipping dates and arrival dates, respectively. The transportation means 12817 stores transportation means from the shipping base to the arrival base. The amount 12818 stores amounts of products that are transported by the transportation means from the shipping base to the arrival base.

According to the first record, the product item “component A” is transported from the base “S11” to the base “A1” according to the alleviated constraint of scenario No. “3” on “7/16” using “ship” by amount of “200”, so that the product item arrives on “8/6”.

### Embodiment 1

### Summary

As discussed thus far, the procurement plan preparation device 10 according to the embodiment 1 creates the alleviated constraint combination list 1231 that is configured so that the fill rate is increased by alleviating the constraints. The operator selects any one of the alleviated scenarios among the combinations. The alleviated constraints may be created in various terms of such as statistical processing results or hearing results. Thus various alternative procurement plans may be prepared other than merely increasing or decreasing supply amounts or consumption amounts.

In addition, the number of alternative procurement plans prepared by the procurement plan preparation device 10 according to the embodiment 1 is limited to the total number of combinations of alleviated constraints. Thus the alternative procurement plans may be efficiently prepared within limited numbers compared to recreating all constraints.

In addition, the procurement plan preparation device 10 according to the embodiment 1 filters the alleviated constraint combination list 1231 by the product item selection area 14111 and by the feasibility selection area 14112. Accordingly, the operator can more efficiently select the alleviated scenarios. By displaying the result sorted by the fill rate, the transportation cost, and the feasibility 12317, the operator can consider alternative procurement plans limited to effective and feasible ones. Thus the operator can make a decision within short time.

### Embodiment 2

In the embodiment 1, the simulation is performed for all alleviated scenarios (all combinations of alleviated constraints). However, it may be assumed that the simulation may be omitted for alleviated scenarios that would not be selected, thereby reducing computational loads. Thus in an embodiment 2 of the present invention, a configuration example will be described where combinations of alleviated constraints which are not necessary to be further alleviated are excluded from the target of simulation, thereby omitting unnecessary calculations.

### Embodiment 2

### Basic Concept

An example will be described below using four alleviated scenarios of the scenario No. 12311=“6”-“9” in FIG. 14. Only the forwarded supplies 12316 are different for each of these four alleviated scenarios. Thus if any one of these four scenarios achieves the fill rate 100%, it is assumed that no more one of the forwarded supplies 12316 is required to be alleviated. Thus when the fill rate reaches 100%, simulations can be omitted for subsequent ones of these four scenarios. Similarly in other alleviation axes, with respect to alleviation scenarios that achieve the fill rate of 100%, it is not necessary to consider scenarios with further alleviated one of the same axis. Thus such scenarios may be sipped.

Another example will be described below using two alleviated scenarios of the scenario No. 12311=“8” “14” in FIG. 14. The scenario No. “14” is an alleviated scenario in which the request achievement 12312 is alleviated from the scenario No. “8”. Therefore, if the scenario No. “8” achieves the fill rate of 100%, the simulation may be omitted for the scenario No. “14”. In other words, scenarios with other alleviation axes that are simply further alleviated may be omitted for alleviated scenarios that achieve the fill rate of 100%. It also applies to the scenario No. “9” “15”.

### Embodiment 2

### Device Configuration

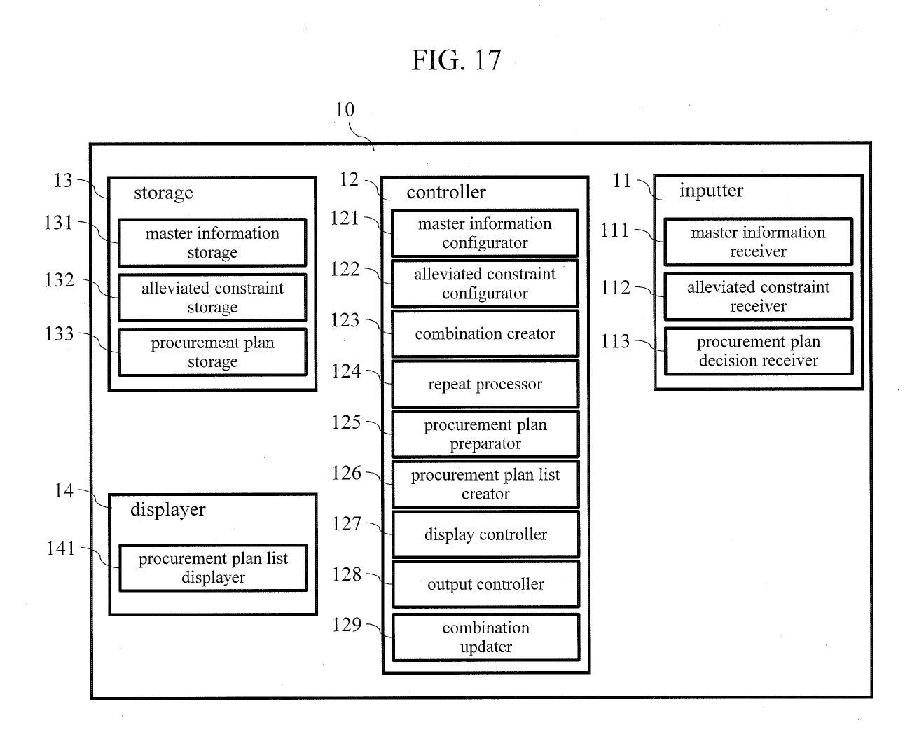

FIG. 17 is a functional block diagram of the procurement plan preparation device 10 according to the embodiment 2. The procurement plan preparation device 10 according to the embodiment 2 includes a combination updater 129 in the controller 12 in addition to the configuration described in the embodiment 1. Other configurations are the same as those of the embodiment 1.

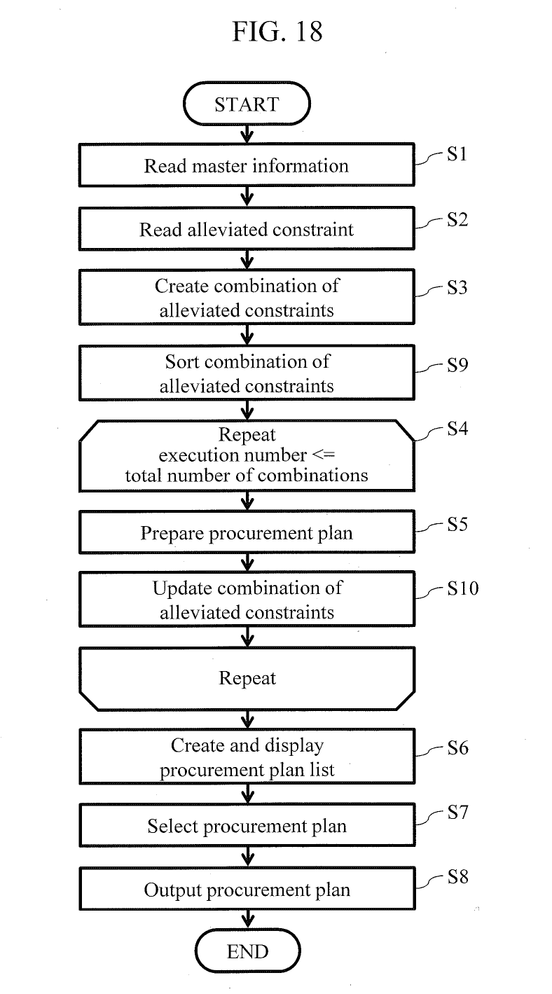

FIG. 18 is a flowchart showing an operation of the procurement plan preparation device 10 according to the embodiment 2. This flowchart includes new steps of S9 and S10 in addition to the flowchart described in FIG. 13. Other steps are the same as those of the embodiment 1. Hereinafter, the additional steps will be described.

### (FIG. 18: Step S9: Sort Combination of Alleviated Constraints)

The combination updater 129 sorts the alleviated constraint combination list 1231 so that it is in the order of constraints from harder ones to looser ones for each of alleviation axes (five alleviation axes of the request achievement 12312-the forwarded supply 12316). In the examples of alleviated constraints described in FIGS. 8-12, the constraints are more alleviated for larger ones of the alleviation No. Thus the alleviated constraint combination list 1231 is sorted in ascending order of the alleviation No.

### (FIG. 18: Step S10: Update Combination of Alleviated Constraints)

If alleviated scenarios are acquired that achieve the fill rate of 100%, the combination updater 129 skips scenarios with simply further alleviated constraints in accordance with the above-mentioned concept. Specifically, the combination updater 129 deletes the alleviated scenarios to be skipped from the alleviated constraint combination list 1231, and updates the list accordingly.

### (FIG. 18: Step S10: Additional Note)

In this step, it is not always necessary to depend on whether the fill rate of 100% is achieved. For example, when an alleviated scenario achieves the fill rate of 95%, other scenarios with simply further alleviated constraints may be skipped. The fill rate threshold for determining whether the combination is skipped may be defined in advance depending on such as characteristics of the procurement plan.

### Embodiment 2

### Summary

As discussed thus far, during simulations for each of combinations of alleviated scenarios, the procurement plan preparation device 10 according to the embodiment 2 skips further alleviated scenarios when the fill rate reaches a predetermined threshold. Accordingly, computational load for the simulation is suppressed to improve the operator's working efficiency.

The present invention is not limited to the embodiments, and various modified examples are included. The embodiments are described in detail to describe the present invention in an easily understood manner, and the embodiments are not necessarily limited to the embodiments that include all configurations described above.

The configurations, the functions, the processing units, the processing means, etc., may be realized by hardware such as by designing part or all of the components by an integrated circuit. A processor may interpret and execute programs for realizing the functions to realize the configurations, the functions, etc., by software. Information, such as programs, tables, and files, for realizing the functions can be stored in a recording device, such as a memory, a hard disk, and an SSD (Solid State Drive), or in a recording medium, such as an IC card, an SD card, and a DVD.

### REFERENCE SIGNS LIST

10: procurement plan preparation device
11: inputter
111: master information receiver
112: alleviated constraint receiver
113: procurement plan decision receiver
12: controller
121: master information configurator
122: alleviated constraint configurator
123: combination creator
124: repetition processor
125: procurement plan preparator
126: procurement plan list creator
127: display controller
128: output controller
13: storage
131: master information storage
132: alleviated constraint storage
133: procurement plan storage
14: displayer
141: procurement plan list displayer

1. A procurement plan preparation device that corrects a previously-prepared procurement plan to re-prepare the procurement plan, comprising:
an alleviated constraint storage that stores data describing a plurality of second constraints in which a constraint for the procurement plan is alleviated;
a combination creator that creates a combination of the plurality of the second constraints;
a repeater that creates, for each of combinations of the second constraints, a second procurement plan in which the constraint is replaced with the second constraint; and
an outputter that outputs the second procurement plan created by the repeater,
wherein the second constraint is configured by alleviating the constraint to increase a ratio of procurement requests, satisfying a procurement target, included in the procurement plan.

2. The procurement plan preparation device according to claim 1,
wherein the outputter sorts the second procurement plan in descending order of ratio of the procurement request satisfying the constraint, and outputs a sorted result.

3. The procurement plan preparation device according to claim 2,
wherein the second constraint defines a second cost constraint that allows a higher cost than that of a cost constraint defined in the constraint,
wherein the outputter sorts the second procurement plan in descending order of cost allowed by the second cost constraint, and outputs a sorted result.

4. The procurement plan preparation device according to claim 2,
wherein the second constraint defines, along with the second constraint, a probability with which the second constraint is actually satisfied,
and wherein the outputter sorts the second procurement plan in descending order of the probability, and outputs a sorted result.

5. The procurement plan preparation device according to claim 2,
wherein the procurement plan preparation device comprises an inputter that receives a range instruction specifying a range to be outputted by the outputter regarding one or more of a proportion of the second procurement plan satisfying the constraint, a cost allowed by the second cost constraint, and the probability,
and wherein the outputter outputs only ones of the second procurement plan that have a value within a range specified by the range instruction received by the inputter.

6. The procurement plan preparation device according to claim 2,
wherein the procurement plan preparation device comprises an inputter that receives a range instruction specifying a range to be outputted by the outputter regarding one or more of constraint items defined by the constraint,
and wherein the outputter outputs only ones of the second procurement plan that have a value within a range specified by the range instruction received by the inputter.

7. The procurement plan preparation device according to claim 1,
wherein during creating the second procurement plan for each of combinations of the second constraints, if one of the second procurement plan is acquired in which a proportion of the procurement requests satisfying a procurement target is at or above a predetermined threshold, the repeater skips preparing the second procurement plan for the combination in which the second constraint is further alleviated from when the predetermined threshold is achieved.

8. The procurement plan preparation device according to claim 1,
wherein the second constraint is configured to increase, by reducing the procurement request, a proportion of the procurement requests satisfying a procurement target in the procurement plan.

9. The procurement plan preparation device according to claim 1,
wherein the second constraint is configured to increase, by increasing transportation cost, a proportion of the procurement requests satisfying a procurement target in the procurement plan.

10. The procurement plan preparation device according to claim 1,
wherein the second constraint is configured to increase, by reducing transportation days, a proportion of the procurement requests satisfying a procurement target in the procurement plan.

11. The procurement plan preparation device according to claim 1,
wherein the second constraint is configured to increase, by increasing supply amount corresponding to the procurement request, a proportion of the procurement requests satisfying a procurement target in the procurement plan.

12. The procurement plan preparation device according to claim 1,
wherein the second constraint is configured to increase, by forwarding supply corresponding to the procurement request, a proportion of the procurement requests satisfying a procurement target in the procurement plan.
